(19) United States
(12) Patent Application Publication
(10) Pub. No.: US 2008/0181545 A1
(43) Pub. Date: Jul. 31, 2008

(54) HYDRODYNAMIC BEARING DEVICE AND SPINDLE MOTOR

(76) Inventors: Hisaaki YANO, Ehime (JP); Masafumi Kumoi, Osaka (JP); Yosei Yoshikawa, Ehime (JP); Yukinori Maruyama, Ehime (JP)

Correspondence Address: WENDEROTH, LIND & PONACK L.L.P., 2033 K. STREET, NW, SUITE 800, WASHINGTON, DC, 20006, US

(21) Appl. No.: 12/022,568

(22) Filed: Jan. 30, 2008

(30) Foreign Application Priority Data
Jan. 31, 2007 (JP) 2007-020846
Aug. 30, 2007 (JP) 2007-223418

(51) Int. Cl. F16C 32/06

(52) U.S. Cl. 384/107

(57) ABSTRACT

There is provided a hydrodynamic bearing device having a communicating hole and with a bearing structure such that lubricant tends not to flow out of the bearing openings of the hydrodynamic bearing device even when the hydrodynamic bearing device is subjected to a large impact, as well as a spindle motor in which this hydrodynamic bearing device is installed. A hydrodynamic bearing device has a shaft and a sleeve that rotatably supports the shaft. A thrust flange is formed at one end of the shaft, is equipped with a protrusion that is opposed to a stepped component of the sleeve in the axial direction, and is configured such that the thrust flange does not block a communicating hole when an impact is applied, which suppresses the generation of a cavity near the thrust flange.

### BACKGROUND OF THE INVENTION

1. Field of the Invention

The present invention relates to a hydrodynamic bearing device, and to a spindle motor in which this hydrodynamic bearing device is installed.

2. Description of the Related Art

A hydrodynamic bearing device is what has been used most often in recent years in spindle motors for hard disk drives (hereinafter referred to as HDDs). This is because a hydrodynamic bearing device is superior to a ball bearing in terms of noise suppression, runout precision, and so forth. A “hydrodynamic bearing device” is a bearing in which a lubricating fluid (such as oil or grease) is interposed between a stationary component and a rotating component, pressure is generated by hydrodynamic grooves formed in the stationary component or rotating component, and the stationary component and the rotating component are held in a contact-free state by this pressure.

HDDs are used in small, thin products ranging from desktop personal computers to mobile telephones and mobile players, for example, and therefore the hydrodynamic bearing devices installed in HDDs also need to be made smaller and thinner. As hydrodynamic bearing devices have become smaller and thinner, there is less space available for the design of the hydrodynamic bearing device. For example, although adequate design space has been ensured with hydrodynamic bearing devices used in a 3.5-inch HDD installed in a desktop personal computer or the like, with a 2.5-inch or smaller HDD installed in small, thin products such as mobile telephones and mobile players, it is becoming difficult to ensure enough design space.

Coming up with a design that allows the lubricating fluid necessary for a hydrodynamic bearing device to be properly supported inside the bearing within this limited design space is becoming the most pressing problem. This is because if there is not enough lubricating fluid in the bearing gaps (the portions where pressure is generated by the hydrodynamic grooves between the stationary component and rotating component), the rotating component will rub against the stationary component and eventually seize (become unable to rotate), and as a result, it will be impossible to write or read data to or from the HDD.

End users of mobile telephones, mobile players, and other such products tend to think of a HDD as being just one of the parts that make up the product, similar to a flash memory or the like. Also, few users think that it could easily become impossible to write or read data to or from a HDD. Therefore, if such a problem should occur even once, that end user will end up losing all the data stored on the HDD, and will lose confidence in the product itself. In other words, properly keeping inside the bearing the lubricating fluid necessary for a hydrodynamic bearing device is of the greatest importance for a hydrodynamic bearing device, and is also important for a HDD.

Most of today's hydrodynamic bearing devices have a pocket structure that is open at one end and closed at the other. When a large pressure differential is produced in the bearing by an external impact, the lubricating fluid in the bearing may end up flowing out to relieve this pressure differential. This leakage of the lubricating fluid must be prevented, or, to put it another way, the lubricating fluid necessary for the hydrodynamic bearing device must be properly kept inside the bearing. To this end, research has been conducted into capillary seal structures and hydrodynamic grooves. In most of this various research, the structure has been such that a communicating hole is formed in one of the bearing members (sleeve) constituting the hydrodynamic bearing device, with the goal being to make uniform the pressure differential inside the bearing (inside the pocket structure). Published literature includes Japanese Laid-Open Patent Applications 2005-143227, 2005-257069, and 2005-308057.

With the configuration of the conventional spindle motor 801 and hydrodynamic bearing device 802 shown in FIG. 11, a communicating hole 827 is formed in a sleeve 813. A second opening 827b of the communicating hole 827 is located on the lower face of a stepped component 824 of the sleeve 813 (the portion across, in the axial direction, from a flange 816 serving as a retainer attached to a shaft 814). A first opening 827a of the communicating hole 827 is located at the other end of the sleeve 813. With this configuration, size is reduced in the radial direction by providing the communicating hole 827 to the sleeve 813. Nevertheless, there is a problem in that lubricating fluid 819 leaks to the outside when an impact is imparted, which will be described below.

The flange 816 is opposed to or across from the stepped component 824 of the sleeve 813, and is also opposed to the second opening 827b of the communicating hole 827. When dynamic pressure is generated in hydrodynamic grooves (not shown) of a radial bearing 817, the flange 816, the shaft 814, and a hub 812, which are rotating components, float up. When no impact or other external force is applied, the floating force and the attraction force between a magnet 809 and a magnetic body 829 are balanced, and this ensures a gap between the flange 816 and the second opening 827b of the communicating hole 827.

Also, a capillary seal 821 is formed between the inner peripheral face 812b of a protruding component 812a of the hub 812 and the outer peripheral face 813a of the sleeve 813. The capillary seal 821 prevents the lubricating fluid 819 from leaking out by maintaining equilibrium between the air pressure of the external atmosphere and the surface tension of the lubricating fluid 819.

However, as shown in FIG. 12A, if the motor (hydrodynamic bearing device) should be subjected to a large impact force when dropped, etc., the shaft 814, the hub 812, and the magnet 809, which are rotating components, move suddenly in the axial direction (indicated by the arrows Da). It is noted that the broken lines in the drawing indicate the state prior to this movement. As a result, the balance between the floating force and the attraction force between the magnet 809 and the magnetic body 829 is lost, and the flange 816 moves until it comes into planar contact with the stepped component 824. As a result, the second opening 827b on the flange side is blocked off by the flange 816, and the sudden movement of the flange 816 in the axial direction prevents the lubricating fluid 819 from getting into the lower side of the flange 816. Consequently, the vapor component that has dissolved into the lubricating fluid 819 at ordinary atmospheric pressure creates bubbles or a cavity in a short time in a space 850 in which the shaft 814 and the flange 816 are opposed to a plate 823 in the axial direction, and this generates a negative pressure portion.

As shown in FIG. 12B, when the impact load is eliminated in a state in which a negative pressure portion has been generated in the space 850, the attraction force between the magnet 809 and the magnetic body 829 causes the shaft 814 and the flange 816, which are rotating components, to move in the axial direction (the direction of the arrows Db) and return to their original state. However, because the vapor component constituting the negative pressure portion cannot redissolve into the lubricating fluid in a short time, the space 850 ends up remaining. As a result, the lubricating fluid 819 with substantially the same volume as the space 850 is pushed out toward the bearing openings. As a result, the equilibrium between the air pressure of the external atmosphere and the surface tension of the lubricating fluid 819 of the capillary seal 821 is lost, and the lubricating fluid 819 ends up flowing to the outside.

### SUMMARY OF THE INVENTION

The present invention solves the above problems encountered in the past, and it is an object thereof to provide a hydrodynamic bearing device having a communicating hole and with a bearing structure such that lubricant tends not to flow out of the bearing openings of the hydrodynamic bearing device even when the hydrodynamic bearing device is subjected to a large impact, as well as a spindle motor in which this hydrodynamic bearing device is installed.

To achieve the stated object, the hydrodynamic bearing device in one aspect of the present invention includes a sleeve having a bearing hole that is open on one side and is closed off on the other side, a shaft main body that is inserted in the bearing hole so as to be capable of rotating relative to the sleeve, an annular flange that is housed on the closed side of the bearing hole, is formed at the end of the shaft main body, and has a larger diameter than the outside diameter of the shaft main body, and a hub that is fastened to the shaft main body and is disposed so as to cover the open side of the sleeve. A communicating hole, which has a first opening formed in the end face on the open side of the sleeve and a second opening formed on a face of the sleeve that is opposed to the flange, is formed in the sleeve. A lubricant is present in the communicating hole, in a gap between the shaft main body and the sleeve, and in a gap between the flange and the sleeve. A protrusion is formed on either the sleeve or the flange and protrudes toward the other, radially inward of the second opening.

With this hydrodynamic bearing device, if the hydrodynamic bearing device should be subjected to a large external impact in the axial direction, the protrusion formed on the flange or the sleeve will come into contact with another member, which prevents the face of the sleeve in which the second opening is formed from coming into contact with the flange, and the lubricant flows from the communicating hole into the space formed by the shaft main body, the flange, and the sleeve. Therefore, it is less likely that a negative pressure portion will be generated between the sleeve and the closed-side face of the flange. As a result, it is less likely that the lubricant will leak out from the bearing openings.

Also, the spindle motor pertaining to one aspect of the present invention is equipped with the above-mentioned hydrodynamic bearing device, and its lubricant, which affects the service life of the hydrodynamic bearing device, can be effectively kept inside the hydrodynamic bearing device.

### BRIEF DESCRIPTION OF THE DRAWINGS

FIG. 1 is a cross section of the spindle motor in Embodiment 1 of the present invention;

FIG. 2 is a cross section of the hydrodynamic bearing device in Embodiment 1 of the present invention;

FIG. 3 is a cross section showing the state inside the hydrodynamic bearing device when it has been subjected to an external impact in Embodiment 1 of the present invention;

FIG. 4 is a cross section of the spindle motor and hydrodynamic bearing device in Embodiment 2 of the present invention;

FIG. 5 is a cross section of the spindle motor in Embodiment 3 of the present invention;

FIG. 6 is a cross section of the hydrodynamic bearing device in Embodiment 3 of the present invention;

FIG. 7 is a cross section showing the state inside the hydrodynamic bearing device when it has been subjected to an external impact in Embodiment 3 of the present invention;

FIG. 8 is a cross section of a modification example of the hydrodynamic bearing device in Embodiment 3 of the present invention;

FIG. 9 is a cross section of the spindle motor in Embodiment 4 of the present invention;

FIG. 10 is a cross section of the hydrodynamic bearing device in Embodiment 4 of the present invention;

FIG. 11 is a cross section of a conventional spindle motor; and

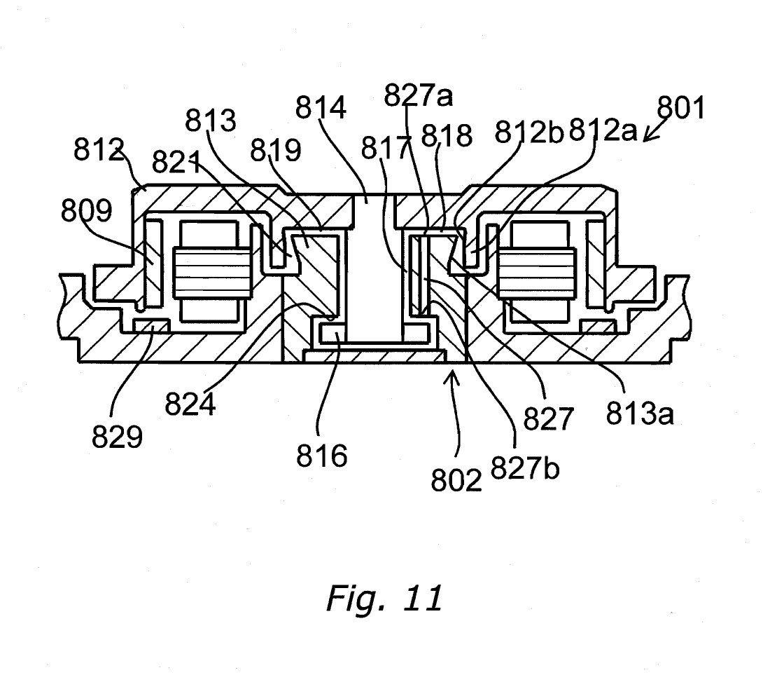

FIG. 12A is a diagram of the state when a negative pressure portion has been generated in a conventional hydrodynamic bearing device, and FIG. 12B is a diagram of the state when lubricant leakage has been caused by a negative pressure portion in a conventional hydrodynamic bearing device.

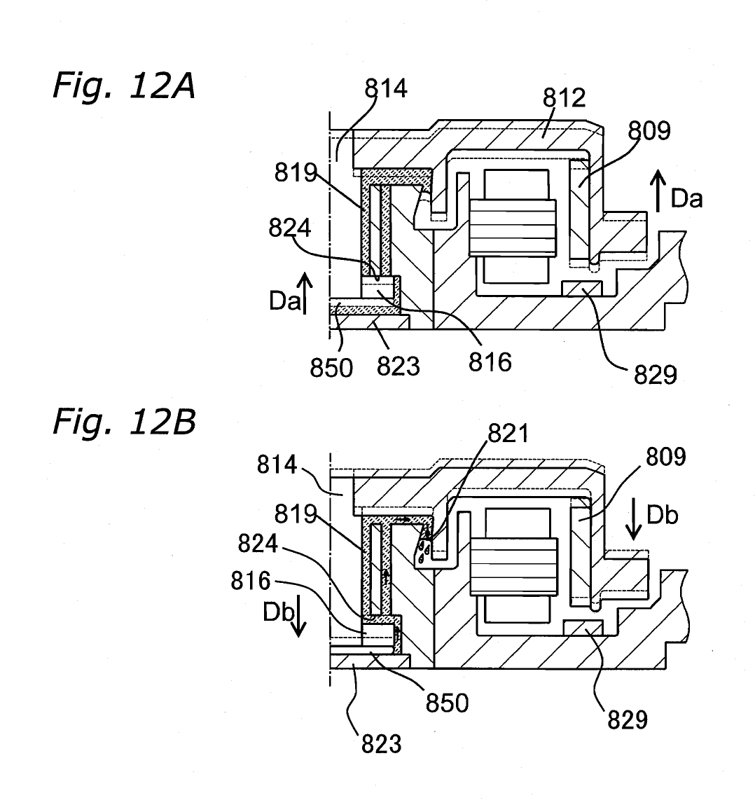

### BEST MODE FOR CARRYING OUT THE INVENTION

Embodiments of the hydrodynamic bearing device and spindle motor of the present invention will now be described in detail along with the drawings.

### Embodiment 1

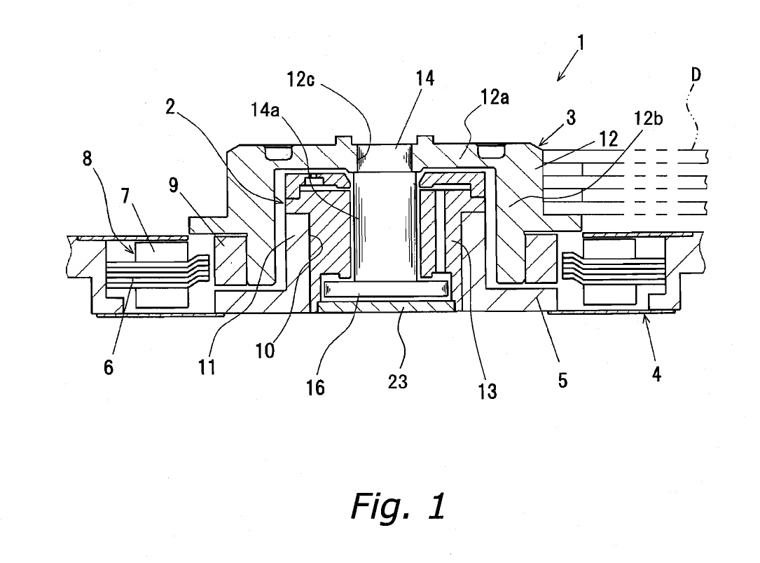

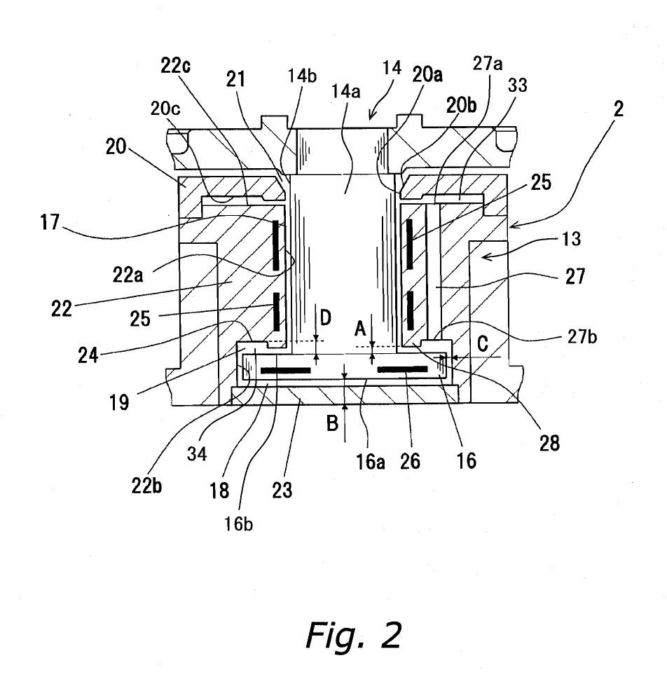

A first working example of the present invention will be described through reference to FIGS. 1 and 2.

FIG. 1 is a cross section of hydrodynamic bearing device 2, and a spindle motor 1 in which this bearing is installed, in a first working example of the present invention. FIG. 2 is a detail view of the hydrodynamic bearing device 2.

In the description of this embodiment, for the sake of convenience the up and down directions in FIGS. 1 and 2 are referred to as the “upward axial direction” and the “downward axial direction,” but these are not intended to limit the directions in the actual attached state of the spindle motor 1.

The spindle motor 1 mainly comprises a rotor component 3, the hydrodynamic bearing device 2 for rotatably supporting the rotor component 3, and a stator component 4. The stator component 4 has a stator 8. The stator 8 includes a stator core 6 fixed to a base 5, and a coil 7 wound around this core. The rotor component 3 has a magnet 9 located on the stator 8 with a radial gap therebetween. The stator 8 and the magnet 9 are together able to generate a rotary magnetic field, and these form a magnetic circuit for imparting rotational force to the rotor component 3. A hole 10 that opens in the axial direction is formed in the approximate center of the base 5. A cylindrical component 11 that extends in the upward axial direction is formed at the edge of the hole 10.

The rotor component 3 is a member that is rotatably supported by the base 5 via the hydrodynamic bearing device 2. The rotor component 3 is formed mainly by a hub 12 around the outer periphery of which is placed a recording disk D, and a shaft 14 that is located on the inner peripheral side of the hub 12 and is supported by a sleeve 13 via the hydrodynamic bearing device 2.

The hub 12 is a cup-shaped member disposed near the sleeve 13 so as to cover it from above. The hub 12 mainly has a disk-shaped component 12a and an outer peripheral cylindrical component 12b that extends in the downward axial direction from the outer peripheral edge thereof. The shaft 14 (discussed below) is fitted into a center hole 12c in the disk-shaped component 12a. The magnet 9 is fixed by an adhesive means or the like to the lower outer peripheral face of the outer peripheral cylindrical component 12b, and the recording disk D is fitted to the upper outer peripheral face.

The magnet 9 is opposed to the stator 8 via a radial gap. When power is turned on to the coil 7 of the stator 8, the stator 8 and the magnet 9 interact electromagnetically, which generates torque in the rotor component 3.

The upper end of the shaft 14 is fitted in the center hole 12c of the hub 12. A thrust flange 16 is fixed in a shaft main body 14a of the shaft 14. That is, the shaft 14 is constituted by the cylindrical shaft main body 14a and the disk-shaped thrust flange 16.

The hydrodynamic bearing device 2 is a bearing portion for supporting the rotor component 3 rotatably with respect to the stator component 4. The hydrodynamic bearing device 2 has a pocket structure that is open at one end and closed at the other. As shown in FIG. 2, the hydrodynamic bearing device 2 more specifically comprises mainly the shaft 14 fixed to the rotor component 3, and the sleeve 13 that is fixed to the base 5 and rotatably supports the shaft 14. The hydrodynamic bearing device 2 has a radial bearing 17 and a thrust bearing 18 (discussed below) as hydrodynamic components.

The sleeve 13 is made up of a substantially hollow, cylindrical sleeve main body 22, and a disk-shaped thrust plate 23 that closes the lower part of the sleeve main body 22. The sleeve main body 22 has a through-hole extending through its center in the axial direction, and in this is formed a first inner peripheral face 22a. The thrust plate 23 is a disk-shaped member, and is fixed to the lower end of the sleeve main body 22, thereby closing the lower end opening of the through-hole. Because of the above, the sleeve 13 has a bearing hole that is open on one side (the upper side in the drawing) and closed off on the other side (the lower side in the drawing).

A stepped component 24 that is contiguous from the first inner peripheral face 22a is formed on the lower end side of the sleeve main body 22. In other words, the stepped component 24 is a closed-side end face of the sleeve 13. The stepped component 24 is formed between the first inner peripheral face 22a of the sleeve main body 22 and a second inner peripheral face 22b that has a larger diameter than the first inner peripheral face 22a, and is a flat surface that faces in the downward axial direction. The stepped component 24 ensures an annular, concave space for accommodating the thrust flange 16 of the shaft 14 (discussed below). The part under the stepped component 24 is closed off by the thrust plate 23. Because of the above, the sleeve 13 forms a cylindrical hollow space formed by the first inner peripheral face 22a of the sleeve main body 22, and a disk-shaped hollow space formed by the thrust plate 23 and the stepped component 24 of the sleeve main body 22. The sleeve main body 22 has an upper end face 22c. In other words, the upper end face 22c is an open-side end face of the sleeve 13.

The shaft main body 14a of the shaft 14 is roughly disposed in a cylindrical hollow space along the through-hole of the sleeve 13. The outer peripheral face 14b of the shaft main body 14a is opposed to the first inner peripheral face 22a of the sleeve main body 22 via a radial gap. The thrust flange 16 is a disk-shaped portion disposed in the disk-shaped hollow space of the sleeve 13. A second space 34 is formed between an upper face 16b of the thrust flange 16 and the stepped component 24 of the sleeve main body 22.

Herringbone-shaped hydrodynamic grooves 25 in a lubricating fluid 19 as the shaft 14 rotates are formed in the first inner peripheral face 22a of the sleeve main body 22. The hydrodynamic grooves 25 consist of a plurality of grooves aligned in the rotational direction, and each groove is a substantially dogleg-shaped groove produced by the linking of a pair of spiral grooves that are inclined in opposite directions with respect to the rotational direction. Thus, the radial bearings 17 are formed aligned in the axial direction by the first inner peripheral face 22a of the sleeve main body 22 of the sleeve 13, the outer peripheral face 14b of the shaft main body 14a of the shaft 14, and the lubricating fluid 19 therebetween. The radial bearing 17 has an unbalanced shape, such as one in which the hydrodynamic pressure is much greater in the linked part of the hydrodynamic grooves (so as to generate hydrodynamic pressure toward the journal center in the lubricating fluid).

The thrust flange 16 has a thrust face 16a that faces downward. A spiral or herringbone-shaped hydrodynamic grooves 26 in the lubricating fluid 19 as the shaft 14 rotates is formed in the thrust face 16a. The hydrodynamic grooves 26 consist of a plurality of grooves aligned in the rotational direction, which support the rotor component 3 from the thrust direction during rotation. Thus, the thrust bearing 18 is formed by the thrust face 16a of the thrust flange 16, the thrust plate 23, and the lubricating fluid 19 therebetween.

The hydrodynamic bearing device 2 has a cover member 20 disposed at the upper end of the sleeve main body 22 so as to cover the sleeve main body 22. The outer peripheral part of the cover member 20 is fixed to the sleeve main body 22. The lower, inner face 20c of the cover member 20 is formed as an annular recess, and the cover member 20 forms a first space 33 between itself and the upper end face 22c of the sleeve main body 22.

The lubricating fluid 19 in each bearing component is sealed by a capillary seal 21 formed by the cover member 20. The capillary seal 21 is a structure for preventing leakage of the lubricating fluid 19 from the bearing gaps. The capillary seal 21 is constituted by an inner peripheral face 20a of the cover member 20 and the outer peripheral face 14b of the shaft main body 14a, in the vicinity of the upper end of the sleeve main body 22. More specifically, the capillary seal 21 is constituted by a tapered face 20b provided to the inner peripheral face 20a of the cover member 20. The tapered face 20b is formed so that the radial gap between itself and the outer peripheral face 14b of the shaft main body 14a expands in the upward axial direction. Because of the structure described above, equilibrium is maintained between the air pressure of the external atmosphere and the surface tension of the lubricating fluid 19 held in the hydrodynamic bearing device 2, and this suppresses the movement of the lubricating fluid 19 to outside of the hydrodynamic bearing device 2.

Also, the gaps constituting the bearing 17 and 18 are completely filled with the lubricating fluid 19, an interface is formed only at the capillary seal 21, and this leads to the outside air, so this is a so-called full-fill structure.

A communicating hole 27 that extends in the axial direction is formed in the sleeve main body 22. The communicating hole 27 communicates between the first space 33 and the second space 34. More specifically, the communicating hole 27 has a first opening 27a that is formed in the upper end face 22c and opens into the first space 33, and a second opening 27b that is formed in the stepped component 24 and opens into the second space 34. An annular protrusion 28 is formed on the stepped component 24. The protrusion 28 is an annular projection that is opposed to the upper face 16b of the thrust flange 16 in the axial direction. The lower face of the protrusion 28 in the axial direction is a flat surface, and is closer to the upper face 16b of the thrust flange 16 than the stepped component 24. The protrusion 28 is located radially inward of the first opening 27a of the communicating hole 27.

Thus, with the spindle motor 1 equipped with the hydrodynamic bearing device 2 that is open at one end, the protrusion 28 is formed in the portion of the sleeve main body 22 (specifically, the stepped component 24) that is opposed to the upper face 16b of the thrust flange 16 in the axial direction. Therefore, it is possible to suppress the creation of a strong negative pressure portion that would generate bubbles in the bearing gaps when the rotor component 3 (rotating component) is subjected to a sudden external impact. As a result, it is less likely that the lubricating fluid 19 will leak out from the capillary seal 21.

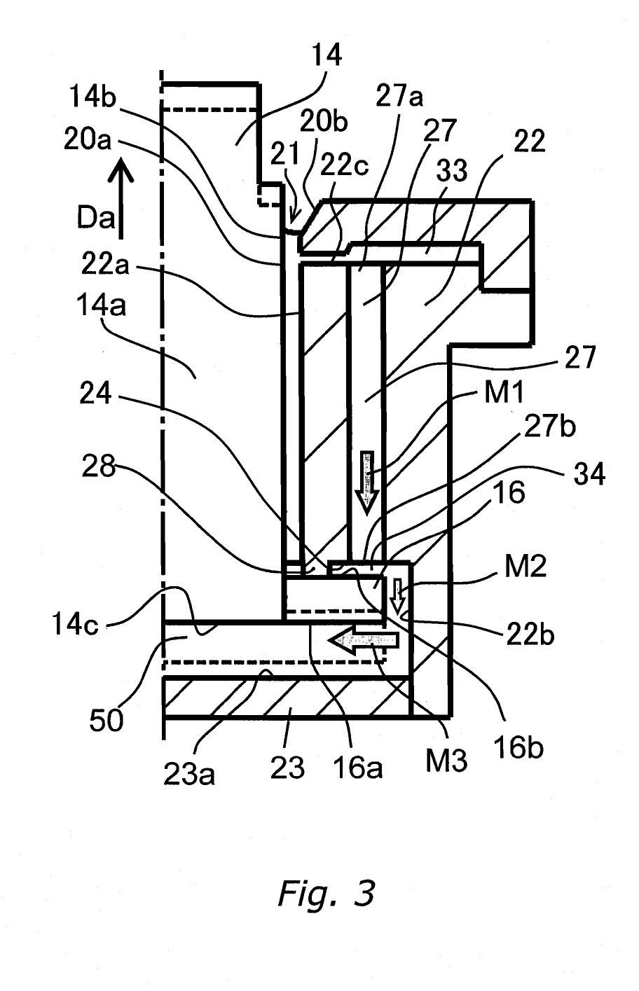

More specifically, the fact that leakage of the lubricating fluid 19 in the event of a sudden external impact is prevented by forming the protrusion 28 will be described through reference to FIG. 3.

As shown in FIG. 3, when the spindle motor is subjected to a sudden external impact, the shaft 14, constituting the rotor component 3 (rotating component) moves in the upward axial direction (in the direction of the arrow Da). It is noted that the broken lines in the drawing indicate the state prior to this movement. As a result, a space 50 is newly formed between the lower face of the shaft 14 (the lower end face 14c of the shaft main body 14a, and the thrust face 16a of the thrust flange 16) and an upper face 23a of the thrust plate 23.

Meanwhile, since the protrusion 28 is formed on the stepped component 24 of the sleeve main body 22, the upper face 16b of the thrust flange 16 comes into contact with the protrusion 28. Accordingly, the upper face 16b of the thrust flange 16 does not come into contact with the portion of the stepped component 24 where the second opening 27b of the communicating hole 27 is formed. That is, even if the thrust flange 16 moves, the second opening 27b of the communicating hole 27 is not blocked off, and the communicating hole 27 and the space 50 can still communicate through the second space 34.

If the space 50 is not filled by the lubricating fluid 19 due to a sudden movement of the shaft 14, the air dissolved in the lubricating fluid 19 will expand and form bubbles. Also, it takes a long time for bubbles that have been produced to dissolve back into the lubricating fluid 19. As a result, it is believed that there is a tendency for negative pressure to occur. If a negative pressure state occurs, the space 50 will not be filled by the lubricating fluid 19. Consequently, once bubbles are produced, they will push out the lubricating fluid 19 filling the bearing gap. The amount of lubricating fluid 19 that is pushed out corresponds to the amount of bubbles produced.

With the present invention, however, since the communicating hole 27 and the space 50 communicate with each other, the lubricating fluid 19 moves from M1 to M2 to M3 as shown in FIG. 3, by which the lubricating fluid 19 is supplied to the space 50, so no strong negative pressure state is produced that would generate bubbles. Even if negative pressure should occur, since the lubricating fluid 19 is supplied through the communicating hole 27, the bubbles produced will have a diameter smaller than the bearing gaps, and no large bubbles will be formed. Therefore, the lubricating fluid 19 will not be pushed out of the capillary seal 21 to outside the bearing.

Because of the above, since the protrusion 28 is formed on the stepped component 24 of the sleeve main body 22, even if the spindle motor is subjected to a sudden external impact, the lubricating fluid 19 will be prevented from leaking out of the capillary seal 21.

Furthermore, by using dimensions for the various bearing gaps (A, B, C, and D) shown in FIG. 2 that satisfy the Relational Formula 1, the lubricating fluid 19 can be prevented from leaking in the event of a sudden external impact, and it is possible to provide a hydrodynamic bearing device with a longer service life, and a spindle motor in which this hydrodynamic bearing device is installed.

D>C>A+B (Formula 1)

A: gap in the axial direction between the protrusion 28 and the thrust flange 16

B: gap in the axial direction between the thrust flange 16 and the thrust plate 23

C: gap in the radial direction between the thrust flange 16 and the second inner peripheral face 22b of the sleeve main body 22

D: gap in the axial direction between the stepped component 24 and the thrust flange 16

More specifically, A+B=0.020 mm, C=0.100 mm, and D=0.125 mm. If the above dimensions are set so as to satisfy Formula 1 in which D is the maximum gap, then in the event of a sudden external impact, the lubricating fluid 19 will be subjected to capillary action that moves it from a location with a wide gap to a location with a narrow gap. In this case, even if a negative pressure portion is generated in the space 50, the lubricating fluid 19 will flow to that negative pressure portion, thereby suppressing the generation of bubbles. As a result of the above, the liquid level in the capillary seal 21 tends not to fluctuate.

Furthermore, when the motor is used for an extended period (and is close to the end of its service life), the weight of the lubricating fluid 19 is reduced by evaporation and so forth. However, if Formula 1 is satisfied, the dynamic pressure-generating portion of the hydrodynamic bearing device 2 will be filled with the lubricating fluid 19 until the end, so the service life is longer than that of a conventional bearing.

### Embodiment 2

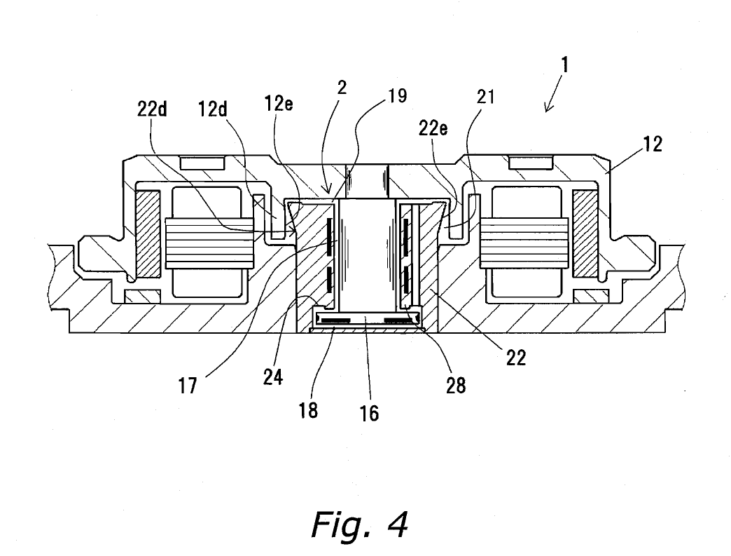

FIG. 4 is a cross section of the spindle motor in Embodiment 2 of the present invention. In FIG. 4, those portions that provide the same effect as in Embodiment 1 are numbered the same, and will not be described again.

In FIG. 4, the hydrodynamic bearing device 2 has the radial bearing 17 and the thrust bearing 18 as hydrodynamic components. Further, the lubricating fluid 19 in the various bearing components is sealed by the capillary seal 21. The gaps constituting the bearing 17 and 18 are completely filled with the lubricating fluid 19, an interface is formed only at the capillary seal 21, and this leads to the outside air, so this is a so-called full-fill structure.

The capillary seal 21 is a structure for preventing leakage of the lubricating fluid 19 from the bearing gaps, and is made up of an outer peripheral face 22d of the sleeve main body 22 and an inner peripheral face 12e of an inner peripheral cylindrical component 12d of the hub 12. To describe this more specifically, the capillary seal 21 is made up of a tapered component 22e provided to the outer peripheral face 22d at the upper end of the sleeve main body 22. The tapered component 22e is formed such that the radial gap between itself and the inner peripheral face 12e of the inner peripheral cylindrical component 12d expands in the downward axial direction. Because of the structure described above, equilibrium is maintained between the air pressure of the external atmosphere and the surface tension of the lubricating fluid 19 held in the hydrodynamic bearing device 2, and this suppresses the movement of the lubricating fluid 19 to outside of the hydrodynamic bearing device 2.

As above, the difference in this constitution from that in Embodiment 1 is that the capillary seal 21 is formed between the outer peripheral face 22d of the sleeve 13 and the inner peripheral face 12e of the inner peripheral cylindrical component 12d of the hub 12. Again in this embodiment, the protrusion 28 is formed across from the thrust flange 16, on the stepped component 24 of the sleeve main body 22. Therefore, the same effect as in the above embodiment is obtained.

### Embodiment 3

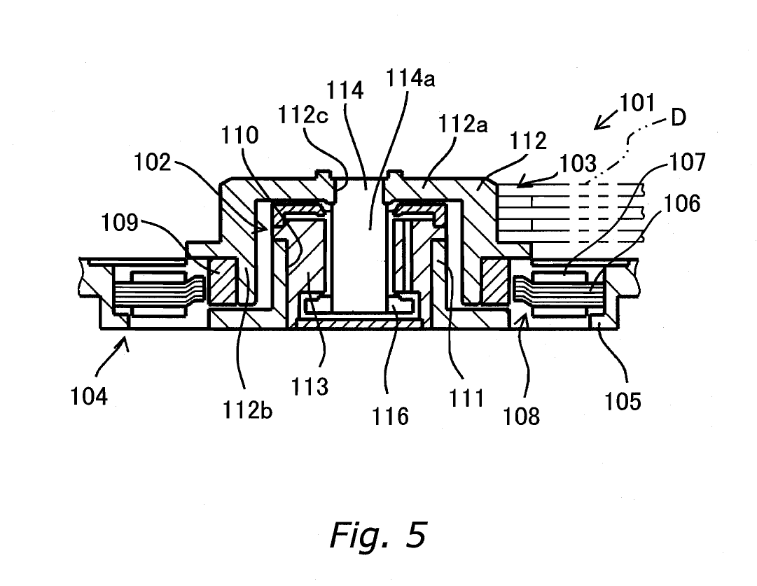

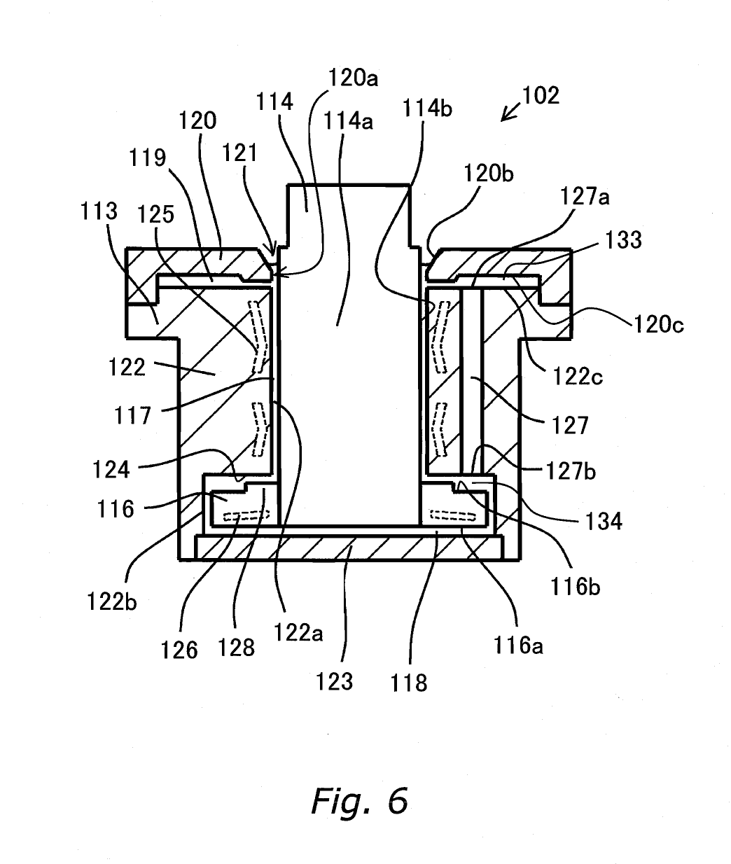

Embodiment 3 of the present invention will be described through reference to FIGS. 5 and 6. FIG. 5 is a cross section of a hydrodynamic bearing device 102 and a spindle motor 101 equipped with the same, in Embodiment 3 of the present invention. FIG. 6 is a cross section of the hydrodynamic bearing device 102.

In the description of this embodiment, for the sake of convenience the up and down directions in FIGS. 5 and 6 are referred to as the “upward axial direction” and the “downward axial direction,” but these are not intended to limit the directions in the usage state of the spindle motor 101.

The spindle motor 101 mainly includes a rotor component 103, the hydrodynamic bearing device 102 for rotatably supporting the rotor component 103, and a stator component 104. The stator component 104 has a stator 108. The stator 108 is composed of a stator core 106 fixed to a base 105, and a coil 107 wound around this core.

The rotor component 103 has a magnet 109 located on the stator 108 with a radial gap therebetween. The stator 108 and the magnet 109 are together able to generate a rotary magnetic field, and these form a magnetic circuit for imparting rotational force to the rotor component 103. A base hole 110 that opens in the axial direction is formed in the approximate center of the base 105. A cylindrical component 111 that extends in the upward axial direction is formed at the edge of the hole 110.

The rotor component 103 is a member that is rotatably supported by the base 105 via the hydrodynamic bearing device 102. The rotor component 103 is formed mainly by a hub 112 around the outer periphery of which is placed a recording disk D, and a shaft 114 that is located on the inner peripheral side of the hub 112 and is supported by a sleeve 113 via the hydrodynamic bearing device 102.

The hub 112 is a cup-shaped member disposed near the sleeve 113 so as to cover it from above. The hub 112 mainly has a disk-shaped component 112a and an outer peripheral cylindrical component 112b that extends in the downward axial direction from the outer peripheral edge thereof. The shaft 114 is fitted into a center hole 112c in the disk-shaped component 112a. The magnet 109 is fixed by an adhesive means or the like to the lower outer peripheral face of the outer peripheral cylindrical component 112b.

The magnet 109 is opposed to the stator 108 via a radial gap. When power is turned on to the coil 107 of the stator 108, the stator 108 and the magnet 109 interact electromagnetically, which generates torque in the rotor component 103.

The upper end of the shaft 114 is fitted in the center hole 112c of the hub 112. A thrust flange 116 is fixed to the lower end of a shaft main body 114a. That is, the shaft 114 is constituted by the cylindrical shaft main body 114a and the disk-shaped thrust flange 116.

The hydrodynamic bearing device 102 is a bearing portion for supporting the rotor component 103 rotatably with respect to the stator component 104. The hydrodynamic bearing device 102 is a type that is closed at one end. As shown in FIG. 6, the hydrodynamic bearing device 102 more specifically includes mainly the shaft 114 fixed to the rotor component 103, and the sleeve 113 that is fixed to the base 105 and rotatably supports the shaft 114. The hydrodynamic bearing device 102 has a radial bearing 117 and a thrust bearing 118 (discussed below) as hydrodynamic components.

The sleeve 113 is made up of a substantially hollow, cylindrical sleeve main body 122, and a disk-shaped thrust plate 123 that closes the lower part of the sleeve main body 122. The sleeve main body 122 has a through-hole extending through its center in the axial direction, and in this is formed a first inner peripheral face 122a. The thrust plate 123 is a disk-shaped member, and is fixed to the lower end of the sleeve main body 122, thereby closing the lower end opening of the through-hole. Because of the above, the sleeve 113 has a bearing hole that is open on one side (the upper side in the drawing) and closed off on the other side (the lower side in the drawing).

A stepped component 124 that is contiguous from the first inner peripheral face 122a is formed on the lower end side of the sleeve main body 122. The stepped component 124 is formed between the first inner peripheral face 122a of the sleeve main body 122 and a second inner peripheral face 122b that has a larger diameter than the first inner peripheral face 122a, and forms a flat surface that faces in the downward axial direction. The stepped component 124 ensures an annular, concave space for accommodating the thrust flange 116 of the shaft 114 (discussed below). Because of the above, the sleeve 113 forms a cylindrical hollow space formed by the first inner peripheral face 122a of the sleeve main body 122, and a disk-shaped hollow space formed by the thrust plate 123, the second inner peripheral face 122b, and the stepped component 124 of the sleeve main body 122. The sleeve main body 122 has an upper end face 122c.

The shaft main body 114a of the shaft 114 is roughly disposed in a cylindrical hollow space along the through-hole of the sleeve 113. The outer peripheral face 114b of the shaft main body 114a is opposed to the first inner peripheral face 122a of the sleeve main body 122 via a microscopic radial gap. The thrust flange 116 is a disk-shaped portion disposed in the disk-shaped hollow space of the sleeve 113. A second space 134 is formed between the upper face 116b of the thrust flange 116 and the stepped component 124 of the sleeve main body 122.

Herringbone-shaped hydrodynamic grooves 125 for generating dynamic pressure in a lubricating fluid 119 as the shaft 114 rotates are formed in the first inner peripheral face 122a of the sleeve main body 122. The hydrodynamic grooves 125 consist of a plurality of grooves aligned in the rotational direction, and each groove is a substantially dogleg-shaped groove produced by the linking of a pair of spiral grooves that are inclined in opposite directions with respect to the rotational direction. Thus, the radial bearings 117 are formed aligned in the axial direction by the first inner peripheral face 122a of the sleeve main body 122 of the sleeve 113, the outer peripheral face 114b of the shaft main body 114a, and the lubricating fluid 119 therebetween. With this radial bearing 117, the hydrodynamic grooves 125 have an unbalanced shape such that the hydrodynamic pressure works from the upward axial direction to the downward axial direction.

A thrust face 116a is formed on the lower side of the thrust flange 116. Spiral or herringbone-shaped hydrodynamic grooves 126 in the lubricating fluid 119 as the shaft 114 rotates are formed in the thrust face 116a. The hydrodynamic groove 126 consists of a plurality of grooves aligned in the rotational direction, which generate dynamic pressure that supports the rotor component 103 in the thrust direction during rotation. Thus, the thrust bearing 118 is formed by the thrust face 116a of the thrust flange 116, the thrust plate 123, and the lubricating fluid 119 therebetween.

The hydrodynamic bearing device 102 has a cover member 120 disposed at the upper end of the sleeve main body 122 so as to cover the sleeve main body 122. The outer peripheral part of the cover member 120 is fixed to the sleeve main body 122. A lower face 120c of the cover member 120 is formed as an annular recess, and the cover member 120 forms a first space 133 between itself and the upper end face 122c of the sleeve main body 122.

The lubricating fluid 119 in each bearing component is sealed by a capillary seal 121 formed by the cover member 120. The capillary seal 121 is a structure for preventing leakage of the lubricating fluid 119 from the radial bearing 117. The capillary seal 121 is constituted by the inner peripheral face 120a of the cover member 120 and the outer peripheral face 114b of the shaft main body 114a, in the vicinity of the upper end of the sleeve main body 122. More specifically, the capillary seal 121 is constituted by a tapered face 120b provided to the inner peripheral face 120a of the cover member 120. The tapered face 120b is formed so that the radial gap between itself and the outer peripheral face 114b of the shaft main body 114a expands in the upward axial direction. Because of the structure described above, equilibrium is maintained between the air pressure of the external atmosphere and the surface tension of the lubricating fluid 119 held in the hydrodynamic bearing device 102, and this suppresses the movement of the lubricating fluid 119 to outside of the hydrodynamic bearing device 102.

Also, the gaps constituting the bearings 117 and 118 are completely filled with the lubricating fluid 119, an interface is formed only at the capillary seal 121, and this leads to the outside air, so this is a so-called full-fill structure.

A communicating hole 127 that extends in the axial direction is formed in the sleeve main body 122. The communicating hole 127 communicates between the first space 133 and the second space 134. The communicating hole 127 has a first opening 127a that is formed in the upper end face 122c and opens into the first space 133, and a second opening 127b that is formed in the stepped component 124 and opens into the second space 134.

An annular protrusion 128 is formed on the upper face 116b of the thrust flange 116. The protrusion 128 is an annular projection that is opposed to the stepped component 124 of the sleeve main body 122 in the axial direction. The upper face of the protrusion 128 in the axial direction is a flat surface, and is closer to the stepped component 124 than the upper face 116b. The protrusion 128 is located radially inward of the second opening 127b of the communicating hole 127.

Thus, with the spindle motor 101 equipped with the hydrodynamic bearing device 102 that is open at one end, the protrusion 128 is formed on the upper face 116b of the thrust flange 116 that is opposed to the stepped component 124 of the sleeve main body 122 in the axial direction. Therefore, it is possible to suppress the creation of a strong negative pressure portion that would generate bubbles in the bearing gaps when the rotor component 103 (rotating component) is subjected to a sudden external impact. As a result, the lubricating fluid 119 can be prevented from leaking out from the capillary seal 121.

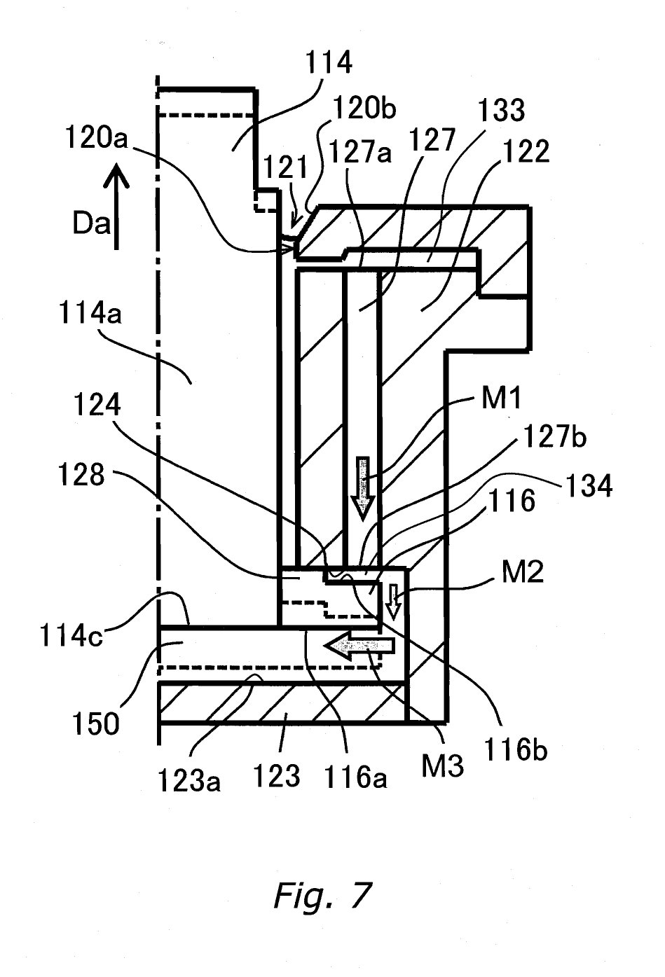

More specifically, the fact that leakage of the lubricating fluid 119 in the event of a sudden external impact is prevented by forming the protrusion 128 will be described through reference to FIG. 7.

As shown in FIG. 7, when the spindle motor is subjected to a sudden external impact, the shaft 114, constituting the rotor component 103 (rotating component), moves in the upward axial direction (in the direction of the arrow Da). It is noted that the broken lines in the drawing indicate the state prior to this movement. As a result, a space 150 is newly formed between the lower face of the shaft 114 (the lower end face 114c of the shaft main body 114a, and the thrust face 116a of the thrust flange 116 in the downward axial direction) and the upper face 123a of the thrust plate 123.

Meanwhile, since the protrusion 128 is formed on the upper face 116b of the thrust flange 116, the protrusion 128 comes into contact with the stepped component 124 of the sleeve main body 122. Accordingly, the upper face 116b of the thrust flange 116 does not come into contact with the portion of the stepped component 124 where the second opening 127b of the communicating hole 127 is formed. That is, even if the thrust flange 116 moves, the second opening 127b of the communicating hole 127 is not blocked off, and the communicating hole 127 and the space 150 can still communicate through the second space 134.

If the space 150 is not filled by the lubricating fluid 119 due to a sudden movement of the shaft 114, the air dissolved in the lubricating fluid 119 will expand and form bubbles. Also, it takes a long time for bubbles that have been produced to dissolve back into the lubricating fluid 119. As a result, it is believed that there is a tendency for negative pressure to occur. If a negative pressure state occurs, the space 150 will not be filled by the lubricating fluid 119. Consequently, once bubbles are produced, they will push out the lubricating fluid 119 filling the bearing gap. The amount of lubricating fluid 119 that is pushed out corresponds to the amount of bubbles produced.

With the present invention, however, since the communicating hole 127 and the space 150 communicate with each other, the lubricating fluid 119 moves from M1 to M2 to M3 as shown in FIG. 7, by which the lubricating fluid 119 is supplied to the space 150, so no strong negative pressure state is produced that would generate bubbles. Even if negative pressure should occur, since the lubricating fluid 119 is supplied through the communicating hole 127, the bubbles produced will have a diameter smaller than the bearing gaps, and no large bubbles will be formed. Therefore, the lubricating fluid 119 will tend not to be pushed out of the capillary seal 121 to outside the bearing.

Because of the above, since the protrusion 128 is formed on the upper face 116b of the thrust flange 116, even if the spindle motor is subjected to a sudden external impact, the lubricating fluid 119 will be prevented from leaking out of the capillary seal 121.

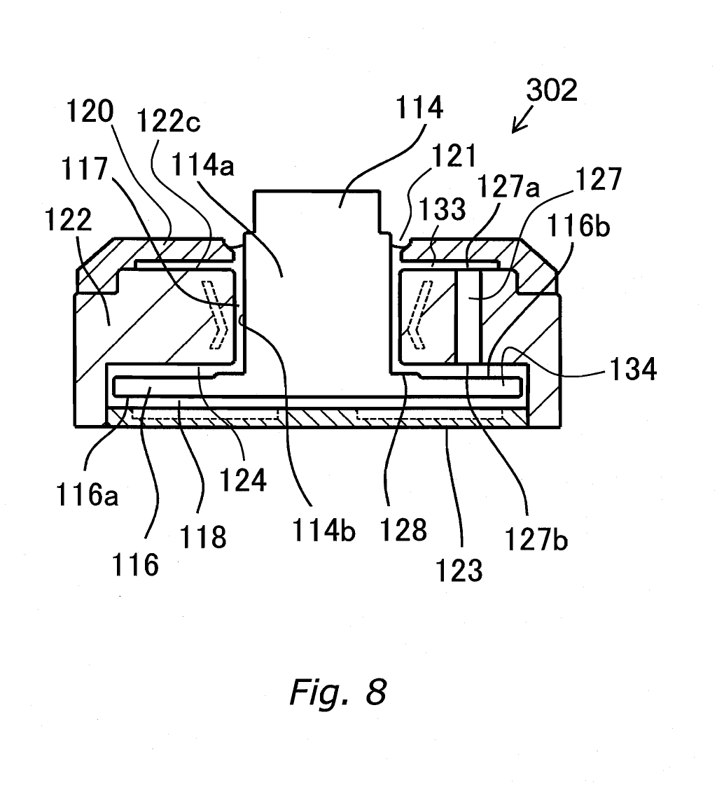

The thrust flange 116 and the shaft main body 114a were described above as being separate parts, but this is not necessarily the case. For instance, with the hydrodynamic bearing device 302 shown in FIG. 8, the axial length of the radial bearing 117 is shortened and the radial length of the thrust bearing 118 is lengthened to make the bearing thinner, and this ensures good stiffness as a hydrodynamic bearing device.

Again in this embodiment, the protrusion 128 that is opposed to the sleeve main body 122 is formed on the thrust flange 116. Also, the communicating hole 127 extends in the axial direction inside the sleeve main body 122. The communicating hole 127 has a first opening 127a that is formed in the upper end face 122c and opens into the first space 133, and a second opening 127b that is formed in the stepped component 124 and opens into the second space 134. Therefore, the same effect is obtained as in the above embodiment.

Since the thrust flange 116 has a large outside diameter and a small thickness, it is formed integrally with the shaft main body 114a to ensure squareness with respect to the shaft 114. The shaft 114 constitutes the radial bearing 117 and the thrust bearing 118. The radial bearing component forms a bearing gap of about 1 to 5 μm, and the thrust bearing component about 10 to 30 μm, so high precision is needed, and grinding is performed.

An example of the grinding of the shaft 114 is to first grind the outer peripheral face 114b constituting the radial bearing 117, then grind the upper face 116b of the thrust flange 116, then grind the thrust face 116a of the thrust flange 116 using the ground upper face 116b as the receiving face, and finally grind the outer peripheral face 114b again using the thrust face 116a of the thrust flange 116 as a reference. The grinding steps are not limited to the above.

The precision needed for the shaft 114 is the squareness, flatness, or other such dimensional precision between the outer peripheral face 114b and the thrust face 116a of the thrust flange 116. Since this dimensional precision is achieved by precise machining (grinding), the hub fastened to the shaft 114 (rotating component) is able to rotate precisely with respect to the rotational center axis. Furthermore, it is possible to prevent contact between a magnetic recording disk installed on the hub and the head used to read and write data.

Furthermore, just the protrusion 128 is ground, rather than the entire upper face 116b of the thrust flange 116, so that flatness and squareness of the thrust flange 116 with respect to the shaft outer peripheral face 114b can be obtained easily and with good precision. Also, the protrusion 128 can be ground at the same time the outer peripheral face 114b is ground. In the above case, since not the entire thrust flange 116 is ground, the grinding can be completed in less time, and when the grinding stone (whetstone) wears down, fine tuning work will be simplified.

As discussed above, precision rotation around the rotational center axis can be achieved by grinding just the protrusion 128 of the thrust flange 116 in the upward axial direction. As a result, the dimensions of the gap of the capillary seal 121 formed to prevent leakage of the lubricating fluid can be set very precisely, so leakage of the lubricating fluid in the event of a sudden impact can be prevented more effectively.

### Embodiment 4

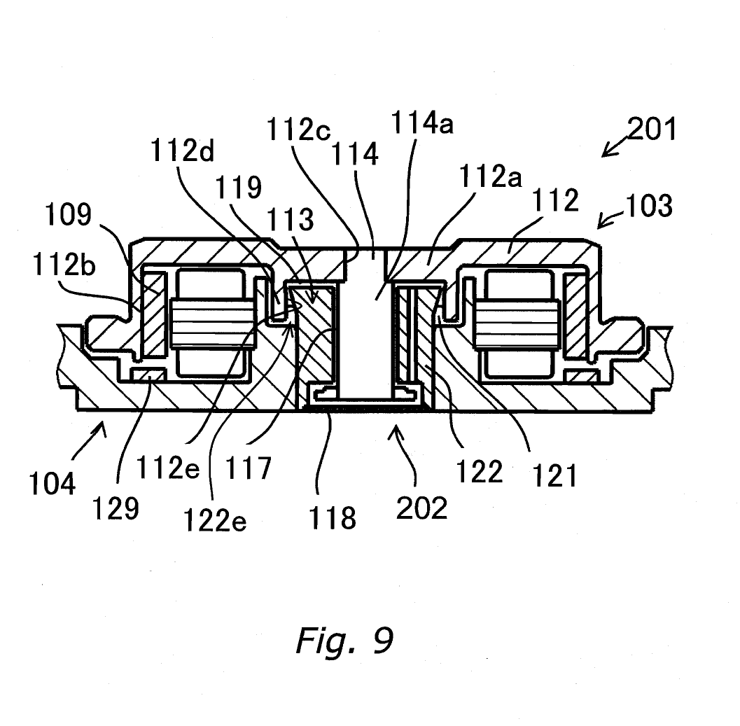

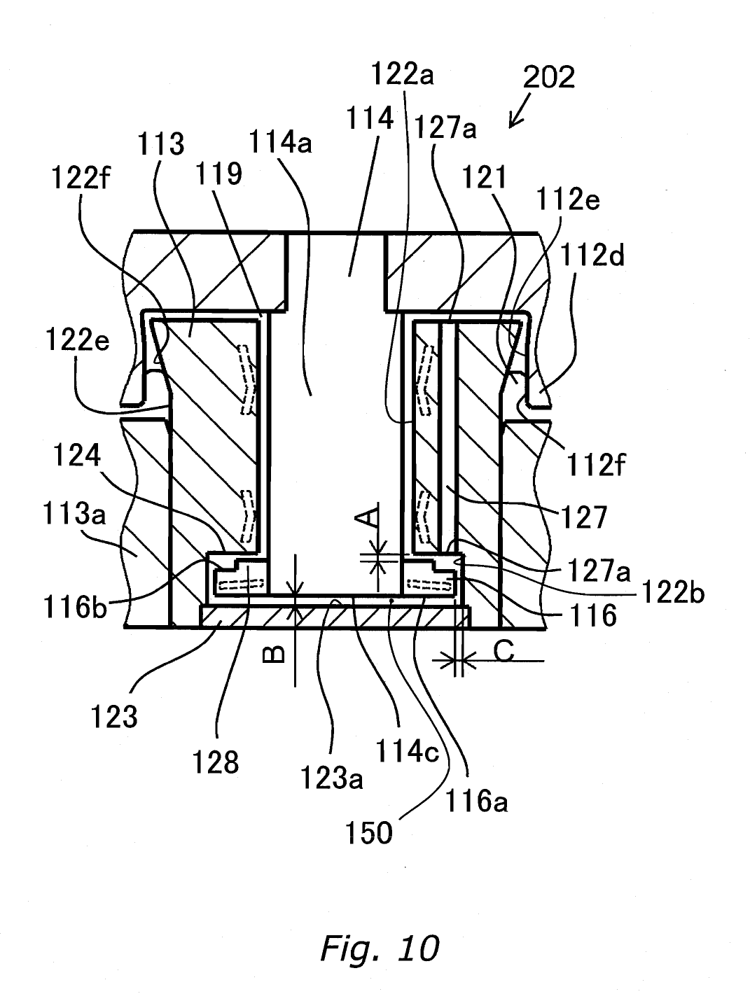

Embodiment 4 of the present invention will now be described through reference to FIGS. 9 and 10. FIG. 9 is a cross section of a spindle motor 201 in Embodiment 4 of the present invention.

FIG. 10 is a cross section of a hydrodynamic bearing device 202 installed in the spindle motor of Embodiment 4.

In FIGS. 9 and 10, those portions that provide the same effect as in Embodiment 3 are numbered the same, and will not be described again.

The hub 112 constituting the rotor component 103 is a cup-shaped member disposed near the sleeve 113 so as to cover it from above. The hub 112 mainly has a disk-shaped component 112a and an outer peripheral cylindrical component 112b that extends in the downward axial direction from the outer peripheral edge thereof. The hub 112 further has an inner peripheral cylindrical component 112d that protrudes in the downward axial direction from the inner peripheral part of the disk-shaped component 112a. The shaft 114 (discussed below) is fixed in a center hole 112c in the disk-shaped component 112a. The magnet 109 is fixed by an adhesive means or the like to the lower inner peripheral face of the outer peripheral cylindrical component 112b.

The hydrodynamic bearing device 202 has a radial bearing 117 and a thrust bearing 118 as hydrodynamic components. The lubricating fluid 119 in the bearing is sealed by the capillary seal 121.

The capillary seal 121 is a structure for preventing leakage of the lubricating fluid 119 from the radial bearing 117. The capillary seal 121 is constituted by the inner peripheral face 112e of the inner peripheral cylindrical component 112d of the hub 112 and the axially upward portion of the outer peripheral face 122e of the sleeve main body 122 of the sleeve 113. More specifically, the capillary seal 121 is constituted by a tapered face 122f provided to the axially upward portion of the outer peripheral face 122e of the sleeve main body 122. The tapered face 122f is formed so that the radial gap between itself and the inner peripheral face 112e of the inner peripheral cylindrical component 112d of the hub 112 expands in the downward axial direction. Because of the structure described above, equilibrium is maintained between the air pressure of the external atmosphere and the surface tension of the lubricating fluid 119 held in the hydrodynamic bearing device 202, and this suppresses the movement of the lubricating fluid 119 to outside of the hydrodynamic bearing device 202.

In FIG. 10, when the shaft 114, constituting the rotor component 103 (rotating component), moves in the upward axial direction, negative pressure tends to occur between the lower end face of the shaft 114 (the lower end face 114c of the shaft main body 114a and the thrust face 116a of the thrust flange 116) and the upper face 123a of the thrust plate 123 (that is, in the space 150).

However, because the protrusion 128 is formed on the thrust flange 116, the communicating hole 127, the thrust face 116a of the thrust flange 116, and the upper face 123a of the thrust plate 123 communicate with each other, so the lubricating fluid 119 moves from M1 to M2 to M3 as shown in FIG. 7, by which the lubricating fluid 119 is supplied to the space 150. Therefore, no strong negative pressure portion is produced that would result in the lubricating fluid 119 being pushed out from the capillary seal 121 to outside the bearing. Because of the above, since the protrusion 128 is formed on the upper face 116b of the thrust flange 116, even if the spindle motor is subjected to a sudden external impact, the lubricating fluid 119 will be prevented from leaking out of the capillary seal 121.

Furthermore, by using dimensions for the various bearing gaps (A, B, and C) shown in FIG. 10 that satisfy the Relational Formula 2, the lubricating fluid 119 can be prevented from leaking in the event of a sudden external impact, and it is possible to provide a hydrodynamic bearing device with a longer service life, and a spindle motor in which this hydrodynamic bearing device is installed.

C>A+B (2)

A: gap in the axial direction between the protrusion 128 and the stepped component 124

B: gap in the axial direction between the thrust flange 116 and the thrust plate 123

C: gap in the radial direction between the outer peripheral face of the thrust flange 116 and the second inner peripheral face 122b of the sleeve main body 122

More specifically, A+B=0.02 mm and C=0.1 mm. If the above dimensions are set so as to satisfy Formula 2, then in the event of a sudden external impact, the lubricating fluid 119 will be subjected to capillary action that moves it from a location with a wide gap to a location with a narrow gap. In this case, even if a negative pressure portion is generated between the thrust flange 116 and the thrust plate 123, the lubricating fluid 119 will flow to the portion where that negative pressure portion tends to be generated, thereby suppressing the generation of bubbles. As a result of the above, the liquid level in the capillary seal 121 tends not to fluctuate.

Furthermore, when the motor is used for an extended period (and is close to the end of its service life), the weight of the lubricating fluid 119 is reduced by evaporation and so forth. However, if Formula 2 is satisfied, capillary action will move the lubricating fluid 119 from a location with a wide gap to a location with a narrow gap, so the hydrodynamic components of the hydrodynamic bearing device 202 will be filled with the lubricating fluid 119 until the end, and therefore the service life is longer than that of a conventional bearing.

The thrust bearing component is in between the thrust flange 116 and the thrust plate 123 in Embodiment 4, but the present invention is not limited to this configuration. For example, thrust hydrodynamic grooves may be disposed between the disk-shaped component 112a of the hub 112 and the upper end face 122c of the sleeve main body 122, thereby ensuring that there will always be a gap between the thrust flange 116 and the thrust plate 123. In this case, the thrust flange 116 mainly functions as a retainer.

There are no particular restrictions on the shape of the protrusion in the above embodiments, but a ring shape is, of course, good in terms of productivity. However, coining, etching, or the like may instead be used to obtain some shape other than a ring shape, such as an arc shape.

Also, thrust hydrodynamic grooves may be formed on the protrusion or on the sleeve-side end face opposed to the protrusion. This helps to reduce wear in the even of an impact.

A spindle motor for a HDD was described in the above embodiments, but this application is not limited to this. For instance, it can also be applied to a CD, DVD, BD, or other such optical disk apparatus, an MO or other such optical disk apparatus, a laser printer or the like featuring a polygon scanner motor, motors for a rotary head drum of a video tape recorder or a streamer, or the like.

The hydrodynamic bearing device and spindle motor pertaining to the present invention can be used in small, thin products such as mobile telephones and mobile players, and the lubricating fluid can be effectively maintained in the hydrodynamic bearing device even if a sudden impact is imparted. In other words, a hydrodynamic bearing device can be designed that is suited to a small, thin product, and is useful for spindle motors and the like used in magnetic recording disk apparatus and so forth.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing description of the embodiments according to the present invention is provided for illustration only, and not for the purpose of limiting the invention as defined by the appended claims and their equivalents.

What is claimed is:

1. A hydrodynamic bearing device, comprising:
a sleeve having a bearing hole that is open on one side and is closed off on the other side;
a shaft main body that is inserted in the bearing hole so as to be capable of rotating relative to the sleeve;
an annular flange that is housed on the closed side of the bearing hole, is formed at the end of the shaft main body, and has a larger diameter than the outside diameter of the shaft main body; and
a hub that is fastened to the shaft main body and is disposed so as to cover the open side of the sleeve,
wherein a communicating hole, which has a first opening formed in an open-side end face of the sleeve and a second opening formed in a closed-side end face of the sleeve that is opposed to the flange, is formed in the sleeve,
a lubricant is present in the communicating hole, in a gap between the shaft main body and the sleeve, and in a gap between the flange and the sleeve, and
a protrusion is formed on either the sleeve or the flange and protrudes toward the other, radially inward of the second opening.

2. The hydrodynamic bearing device according to claim 1, wherein the protrusion is formed on the closed-side end face of the sleeve that is opposed to the flange.

3. The hydrodynamic bearing device according to claim 1, further comprising, between an inner face of the hub and the open-side end face of the sleeve, an annular cover member that covers the open-side end face of the sleeve and forms a space between itself and the open-side end face of the sleeve,
wherein a lubricant is present in the space, and
the first opening opens into the space.

4. The hydrodynamic bearing device according to claim 1, wherein a space is formed between an inner face of the hub and the open-side end face of the sleeve,
a lubricant is present in the space, and
the first opening opens into the space.

5. The hydrodynamic bearing device according to claim 2, further comprising, between an inner face of the hub and the open-side end face of the sleeve, an annular cover member that covers the open-side end face of the sleeve and forms a space between itself and the open-side end face of the sleeve,
wherein a lubricant is present in the space, and
the first opening opens into the space.

6. The hydrodynamic bearing device according to claim 2, wherein a space is formed between an inner face of the hub and the open-side end face of the sleeve,
a lubricant is present in the space, and
the first opening opens into the space.

7. The hydrodynamic bearing device according to claim 2, wherein the relationship of the gaps formed by the sleeve and the flange satisfies Formula 1:
D>C>A+B (Formula 1)
A: gap in the axial direction between the protrusion and the open-side face of the flange
B: gap in the axial direction between the closed-side face of the flange and the sleeve
C: gap in the radial direction between the outer peripheral face of the flange and the inner peripheral face of the sleeve
D: gap in the axial direction between the closed-side end face of the sleeve and the open-side face of the flange

8. The hydrodynamic bearing device according to claim 5, wherein the relationship of the gaps formed by the sleeve and the flange satisfies Formula 1:
D>C>A+B (Formula 1)
A: gap in the axial direction between the protrusion and the open-side face of the flange
B: gap in the axial direction between the closed-side face of the flange and the sleeve
C: gap in the radial direction between the outer peripheral face of the flange and the inner peripheral face of the sleeve
D: gap in the axial direction between the closed-side end face of the sleeve and the open-side face of the flange

9. The hydrodynamic bearing device according to claim 6, wherein the relationship of the gaps formed by the sleeve and the flange satisfies Formula 1:
D>C>A+B (Formula 1)
A: gap in the axial direction between the protrusion and the open-side face of the flange
B: gap in the axial direction between the closed-side face of the flange and the sleeve
C: gap in the radial direction between the outer peripheral face of the flange and the inner peripheral face of the sleeve
D: gap in the axial direction between the closed-side end face of the sleeve and the open-side face of the flange

10. The hydrodynamic bearing device according to claim 1, wherein the protrusion is formed on a face of the flange that is opposed to the sleeve.

11. The hydrodynamic bearing device according to claim 10, further comprising, between an inner face of the hub and the open-side end face of the sleeve, an annular cover member that covers the open-side end face of the sleeve and forms a space between itself and the open-side end face of the sleeve,
wherein a lubricant is present in the space, and
the first opening opens into the space.

12. The hydrodynamic bearing device according to claim 10, wherein a space is formed between an inner face of the hub and the open-side end face of the sleeve,
a lubricant is present in the space, and
the first opening opens into the space.

13. The hydrodynamic bearing device according to claim 10, wherein the relationship of the gaps formed by the sleeve and the flange satisfies Formula 2:
C>A+B (2)
A: gap in the axial direction between the protrusion and the closed-side end face of the sleeve
B: gap in the axial direction between the closed-side face of the flange and the sleeve
C: gap in the radial direction between the outer peripheral face of the flange and the inner peripheral face of the sleeve

14. The hydrodynamic bearing device according to claim 11, wherein the relationship of the gaps formed by the sleeve and the flange satisfies Formula 2:
C>A+B (2)
A: gap in the axial direction between the protrusion and the closed-side end face of the sleeve
B: gap in the axial direction between the closed-side face of the flange and the sleeve
C: gap in the radial direction between the outer peripheral face of the flange and the inner peripheral face of the sleeve

15. The hydrodynamic bearing device according to claim 12, wherein the relationship of the gaps formed by the sleeve and the flange satisfies Formula 2:
C>A+B (2)
A: gap in the axial direction between the protrusion and the closed-side end face of the sleeve
B: gap in the axial direction between the closed-side face of the flange and the sleeve
C: gap in the radial direction between the outer peripheral face of the flange and the inner peripheral face of the sleeve

16. The hydrodynamic bearing device according to claim 1, wherein the distal end face of the protrusion has been ground.

17. A spindle motor, equipped with the hydrodynamic bearing device according to claim 1.

18. An information apparatus, equipped with the spindle motor according to claim 17.
